(19) United States
(12) Patent Application Publication
(10) Pub. No.: US 2021/0385152 A1
(43) Pub. Date: Dec. 9, 2021

(54) A METHOD OF AND A NODE DEVICE FOR APPLICATION DATA EXCHANGE

(71) Applicant: SIGNIFY HOLDING B.V., EINDHOVEN (NL)

(72) Inventors: Jun YAO, EINDHOVEN (NL); Gang WANG, EINDHOVEN (NL); Rong FAN, EINDHOVEN (NL); Zhizhong ZHANG, EINDHOVEN (NL); Dunfa CHEN, EINDHOVEN (NL)

(21) Appl. No.: 17/270,591

(22) PCT Filed: Jul. 30, 2019
(86) PCT No.: PCT/EP2019/070544

§ 371 Date: Feb. 23, 2021

(30) Foreign Application Priority Data
Aug. 24, 2018 (CN) PCT/CN2018/102341
Nov. 1, 2018 (EP) 18203959.4

(51) Int. Cl. H04L 12/751; H04W 4/38

(52) U.S. Cl. CPC H04L 45/026; H04W 84/18; H04W 4/38

(57) ABSTRACT

In a network (1) of communicatively interconnected (9) node devices (2-8), such as a Zigbee™ enabled mesh network, application data, such as data from or to sensors (12-17) operatively connected (17; 18) to the node devices (2-8), are periodically exchanged by attaching the application data to periodically exchanged operational messages that are to be transmitted by a node device (2-8) in the network (1), such as the link status command messages according to the Zigbee protocol.

### TECHNICAL FIELD

The present disclosure generally relates to the communication of data in a network of communicatively interconnected node devices and, in particular to the exchange of application data, such as sensor related data.

### BACKGROUND

Customer-Premises Equipment, CPE, such as lighting devices having communication capabilities, and Internet of Things, loT, devices are frequently deployed in communication networks comprised of a plurality of communicatively interconnected devices. These devices, generally called node devices, may be movable or mobile devices, operating with a wireless network connection, and/or stationary devices, having either or both a wired and/or wireless network connection. In practice, the term network node device or in short node device or node is generic for all such devices.

Networks of this type are also generally called mesh networks, such as Wireless Mesh Networks, WMNs, Wireless Personal Area Networks, WPANs. Network protocols for exchanging data by networked devices or nodes are generally available and known as ZigBee™, Bluetooth™, as well as WiFi based protocols for wireless networks, and wired bus networks such as DALI™ (Digital Addressable Lighting Interface), DSI (Digital Serial Interface), DMX (Digital Multiplex), and KNX (based systems).

In practice, such a network generally comprises multiple network end nodes, network relay nodes, such as bridges, switches and other electric infrastructure devices and equipment, and at least one network control or coordinator device which may provide access to other networks and the Internet, for example. Such a network control or coordinator device is generically called a backend or gateway device.

In a wireless mesh network, the node devices may communicate in either one of unicast mode and broadcast mode, using the Bluetooth Low Energy, BLE, mesh protocol or the ZigBee protocol, for example. A so-called combo-node device, with both ZigBee and BLE connectivity, may operate as a temporal bridging node between a mobile phone and a ZigBee-based lighting network, for example.

Zigbee communication enabled lighting systems rapidly gain market share and, as a result of which, more and more Zigbee communication enabled peripheral or application devices of different types become available. For example, sensors for monitoring environmental conditions such as humidity, temperature, Infra Red, IR, radiation, Carbon Monoxide, Carbon Dioxide, generally designated COₓ, actuators, camera systems, alarm systems, etc. operatively connected to a node device in the network. The application devices can be called as intelligent or smart devices. The application data produced by these application devices have to be transmitted across the network for use with different node devices in the network but also for exchange outside the network, through a backend or gateway device, for example. Generally, such application data have to be exchanged periodically, either automatically and/or in an inquiry and response mode of operation, for example.

Transmission of such application device data occupies scarce transmission resources of a node device and the network as a whole. In a Zigbee network, for example, if a sensor reporting interval is relatively short, resulting in frequent exchange of several bytes of sensor data, a huge capacity burden on the network is introduced, with the result that some sensor data may be easily lost due to heavy network load, among others caused by other operational and control data messages exchanged over the network.

US2016132758A discloses a bluetooth low energy (BLE)-based asset tag for transmitting a code that identifies an asset, comprising: a device for attachment to the asset; a scanner supported by the device, for scanning the code; a BLE radio supported by the device, for transmitting an advertising beacon in an advertising packet having a payload; and a controller supported by the device, for automatically loading the scanned code into the payload. The advertising packet with the scanned code in the payload is periodically transmitted as a series of beacon pulses.

US2007115821A1 discloses a method for transmitting wireless data using a piggyback technique includes the steps of: a) transmitting a predetermined request packet from a first communication unit to a second communication unit in a predetermined wireless network system; b) determining, by the second communication unit having received the request packet, whether to sequentially transmit an acknowledgement (ACK) packet indicating an acknowledged or unacknowledged state of the request packet and a data packet responding to the request packet to the first communication unit; and c) if it is determined that the ACK packet and the data packet should be sequentially transmitted, including, by the second communication unit, ACK information in a header of the data packet without transmitting the ACK packet to the first communication unit, and transmitting the data packet including the header equipped with the ACK information to the first communication unit.

US2018310301A1 discloses a method includes wirelessly interconnecting network nodes (Wi-Fi Aps) to collectively form the multi-band wireless network configured to provide network access to a client node connected to any of the network nodes. The method further includes establishing a control plane protocol that enables wireless communications of control plane data embedded in periodic frame(s) communicated by the network nodes, and managing the multi-band wireless network by wirelessly communicating the periodic frame(s) between the network nodes in accordance with the control plane protocol.

US2012/163295A1 discloses a mobile terminal in a sensor network selects one of the sensors nodes in the sensor network as an upstream agent, and piggybacks a list of neighboring sensor nodes found in the upstream agent selection process on an upstream packet and transmits the upstream packet to a gateway through the upstream agent. The gateway in the sensor network selects one of the neighboring sensor nodes as a downstream agent using state information of the neighboring sensor nodes in the list, and transmits a downstream packet to the mobile terminal through the selected downstream agent.

WO2011113475A1 discloses a method for communication in a wireless sensor network (WSN) of an industrial control system. The network includes a plurality of device nodes and at least one gateway (GW). The method comprises aggregating in at least one wireless device data originating from at least two data packets. The method comprises receiving at a first node (A) at least one first data packet for a first destination address and aggregating data (IOO, 200) from the at least one data packet with data (I I 0, 115) from at least one second data packet, intended for the same first destination address, forming an aggregated data packet and sending the aggregated data packet to another node or to said gateway (GW). In other aspects of the invention a method, system and a computer program for carrying out the method are described.

United States patent U.S. Pat. No. 7,483,403 B2 describes a method of embedding control messages into channel supervision packet acknowledgements, which are sent in a defined interval to maintain the communication between a node and a cluster head in a star type communication network.

United States patent U.S. Pat. No. 9,788,397 B2 discloses a method of combining link status data and control data. Disclosed is the use of the BLE advertising packet to deliver lighting control or status information, for reducing congestion at the advertising channel and reducing the advertising rate of a node.

Accordingly, there is a need for exchange of application data, such as sensor related data, in a network of communicatively interconnected node devices, limiting the number of data packets to be exchanged and such that data transmission efficiency is increased while the risk of lost data packets is effectively decreased.

### SUMMARY

The above mentioned and other objects are achieved, in a first aspect of the present disclosure, by a method of exchanging application data by a node device in a network of communicatively interconnected node devices, wherein the node device periodically exchanges operational messages in the network, the method comprises exchanging, by the node device, application data in the network by attaching the application data to the periodically exchanged operational messages, wherein said application data are sensor related data and said operational message is a link status command message (20) in a mesh communication enabled network.

The present disclosure is based on the insight that by attaching the application data to data messages that are already periodically exchanged in the network, advantageously use can be made of network control commands and data packets that are anyhow to be transmitted in the network for periodically exchanging the data messages that have to be transmitted in the network. Accordingly, with the present solution, the number of data packets or overhead data that have to be transmitted in the network for exchanging the application data is effectively reduced compared to dedicated data messages for exchanging the application data separately. The present solution thereby effectively increases data transmission efficiency in the network, while not affecting other network commands.

In accordance with the present disclosure, the periodically exchanged operational messages are node device status messages. A node device status message, such as connection or link status message or the like, is a type of data message that is periodically exchanged by each device node in a network for monitoring proper operation of the node device and the network, for example.

The interval or period by which the operational messages are exchanged in a network often can be set, for example dependent on a particular application, such that the method according to the present disclosure is excellently suitable for exchanging time-insensitive, i.e. non-real time, application data.

In a particular embodiment of the present disclosure, the application data are sensor related data, such as sensor related data received from a sensor operationally connected to a node device in the network.

In a Zigbee enabled communication network, the ZigBee routing algorithm uses a path cost metric for route comparison during route discovery and maintenance. In order to compute this metric, a cost, known as the link cost, is associated with each link in the path and link cost values are summed to produce the cost for the path as a whole which, among others, is an indication for the quality of links in the network.

To allow neighbouring node devices to communicate their incoming link costs to each other and to maintain a neighbor node table and routing table for calculating best routing paths, in a Zigbee enabled network, a link status command message or frame is periodically transmitted by the node devices in the network.

In an embodiment according to the present disclosure, in a Zigbee communication enabled network, the application data are exchanged by attaching same to the link status command message, which link status command message comprises a command options field, a link status list field and a network command field, wherein the command options field comprises a flag that is set when application data are attached to the link status command message.

For the purpose of the present disclosure, in a further embodiment, the link status command is adapted such that when the application data flag is set, the command options field represents or comprises application data options, the link status list field represents or comprises a application data list, and the network command payload field comprises the application data to be exchanged.

The application data options field is available for specifying a variety of parameters concerning the application data to be exchanged, whereas the application data list may contain information as to the content of the application data included in the network command payload field, for example.

In a yet further embodiment, an application data entry format is specified, wherein application data options comprise a application data entry number, and the network command payload field comprises a application data source identification or ID, a application data destination identification or ID, application data type and control information, the application data to be exchanged, and time stamp data.

For each entry of application data, the data length is flexible and is set by the application data entry number, indicating the length of the application data to be exchanged, for example in number of data octets. In this embodiment, each node device may have a unique source number or ID from which the application data originate and/or a unique number or ID of a destination to which application received at a node device are to be delivered.

In an even further specification in accordance with the present disclosure, the application data type and control information comprises a application data request/report flag, a maximum node hop number, and a application data type indication.

With this embodiment, a data inquiry or data request mode of operation of a node device, a data delivery or data report mode of operation of a node device and spreading of application data through the network can be effectively indicated and controlled. The maximum node hop number indicates the maximum number of subsequent receiving nodes that may exchange received application data. In general, the maximum node hop number is set according to the estimated distance between source node device and destination node device in the network.

In accordance with the present disclosure, a gateway device or a backend device or server, communicatively connected to the network, for exchanging application data in the network, may operate in a same manner as a node device in the network.

For example, when a gateway device in a Zigbee enabled network requests application data from a application data source operatively connected to a particular node device in the network, in accordance with the present disclosure, when a node device in the network receives a link status command message comprising application data indicating a application data request and the application data source ID in the status command message does match a application data source ID allocated to the receiving node device, the receiving node device prepares and forwards the requested application data in a link status command message.

It is noted that the respective node device will have to set the application data request/report flag in the link status command message exchanged by this node device to signal report of application data.

It will be appreciated that when the interval in which link status command messages are transmitted is too long because the application data have to be reported immediately, the node device may interrupt the periodic sequence of transmitting link status command messages and generate a link status command message at once.

In accordance with the present disclosure, in the event that a node device receives a link status command message relating to application data indicating a application data request and the application data source ID does not match a application data source ID allocated to the receiving node device, the application data will be repeated by the receiving node device in a link status command message if the maximum node hop number is unequal zero and after the maximum node hop number is decreased by one.

That is, the request for application data will not be forwarded by the receiving node device in a link status command message until the maximum node hop number is decreased. In this manner spreading of the request for application data in the network is effectively controlled.

In accordance with the present disclosure, when the node device receives a link status command message relating to application data indicating a application data report and the application data destination ID does not match a application data destination ID allocated to the receiving node device, the application data will be repeated by the receiving node in a link status command message if the maximum node hop number is unequal zero and after the maximum node hop number is decreased by one.

Likewise, in the case of link status command message indicating a report of application data, the application data will not be forwarded by the receiving node device in a link status command message until the maximum node hop number is decreased.

If a node device in the network receives a link status command message having the maximum node hop number equal to zero, the node device will not forward the received application data.

To further prevent spreading of application data in the network, in accordance with the present disclosure, the application data is also not forwarded by a receiving node when at least one of the timestamp indicates a time older than a set time threshold, and a repeat count number of repeated same application data by the receiving node device exceeds a set repeat threshold.

In a second aspect of the present disclosure, a node device, in particular a lighting device, is provided arranged for operating in accordance with the method of the first aspect of the present disclosure.

It will be appreciated that the node device may be provided operating as a relay device, for example. Further, the node device may be comprised by any electric or electronic device other than a lighting device.

In a third aspect of the present disclosure there is provided a computer readable storage medium storing computer program code instructions which, when loaded on to one or more processors, causes the one or more processors to perform the method of the first aspect of the present disclosure.

The abovementioned and other aspects of the present disclosure will be apparent from and elucidated with reference to the embodiments described hereinafter.

### BRIEF DESCRIPTION OF THE DRAWINGS

FIG. 1 illustrates, schematically, a network of communicatively interconnected network node devices and a gateway device.

FIG. 2 shows the link status command format in accordance with the Zigbee™ specification.

FIG. 3 shows the link status command options field of the link status command format shown in FIG. 2, modified in accordance with the present disclosure.

FIG. 4 shows the Zigbee link status command format in accordance with the present disclosure, assuming that application sensor data are attached.

FIG. 5 shows the sensors options format of FIG. 5.

FIG. 6 shows the application sensor data payload format in accordance with FIGS. 4 and 5.

FIG. 7 shows the sensor type and control format in accordance with FIG. 6.

FIG. 8 illustrates, in a flow charge type diagram, operation of a node device with the Zigbee link status command format requesting sensor data, in accordance with the present disclosure.

FIG. 9 illustrates, in a flow charge type diagram, operation of a node device with the Zigbee link status command format reporting sensor data, in accordance with the present disclosure.

FIG. 10 illustrates, schematically, a circuit diagram of an embodiment of a node device in accordance with the present disclosure.

### DETAILED DESCRIPTION

The present disclosure is detailed below with reference to the exchange of sensor related data in a wireless Zigbee™ enabled network and Zigbee enabled devices. Those skilled in the art will appreciate that the present disclosure is not limited to sensor data and Zigbee operated networks and devices, but is applicable to a wide variety of networks of communicatively interconnected node devices, either wired and/or wirelessly, and for the exchange of data of application or peripheral devices operatively connected to a node device in the network, other than sensors. Non-limited examples of other applicable transmission protocols are

Bluetooth™, Thread™, as well as WiFi based protocols and transmission protocols in accordance with a 3GPP standard, and wired bus networks such as DALI™ (Digital Addressable Lighting Interface), DSI (Digital Serial Interface), DMX (Digital Multiplex), and KNX (based systems), wired Ethernet, etc.

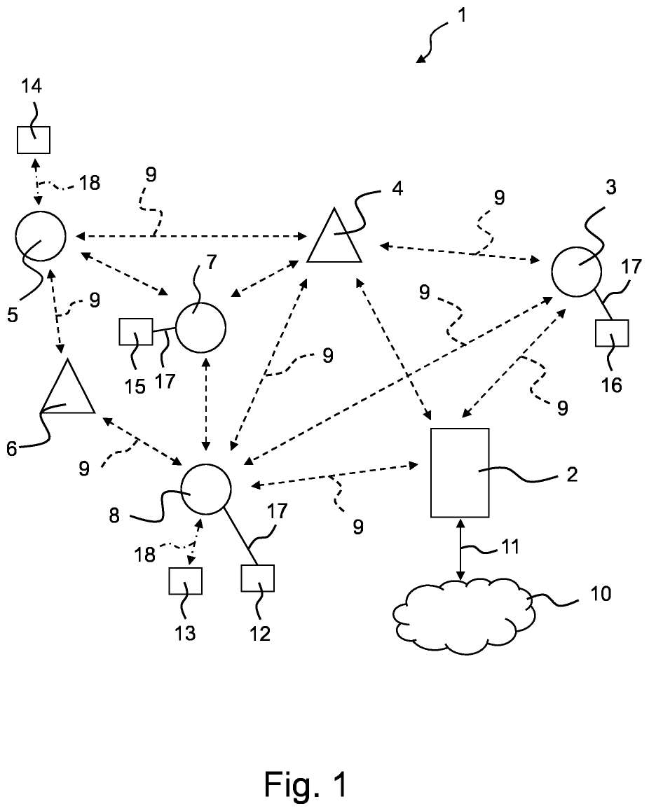

FIG. 1 illustrates, schematically, a network 1 of communicatively interconnected network node devices or in short nodes 3, 4, 5, 6, 7, 8 and a gateway device 2, configured as a so-called Wireless Mesh Network, WMN, also commonly called Wireless Personal Area Network, WPAN, in accordance with the Zigbee protocol.

The network 1 is comprised of multiple network end nodes 3, 5, 8 and network relay nodes 4, 6 such as bridges and switches, for example. The nodes 3-8 may form part of electric or electronic networked devices. The wireless communication connections between the network devices 2-8 are indicated by dashed arrows 9. Those skilled in the art will appreciate that in a general network architecture, node devices may also connect by wired communication links (not shown).

The network end nodes 3, 5, 8 are generic for supporting data communication of a large variety of electric or electronic devices, either mobile or movable devices and/or non-mobile or stationary devices. Examples of such devices are lighting devices, in particular lighting devices comprising Light Emitting Diode, LED, lighting modules, equipment for mobile telephony and data communication, Customer Premises Equipment, CPE, and so-called Internet of Things, loT, devices.

Reference numerals 12-16 designate sensor devices, such as sensors for measuring humidity, temperature, Infra Red, IR, radiation, Carbon Monoxide, Carbon Dioxide, generally designated COₓ, actuators, camera systems, alarm systems, etc. In the embodiment shown, the sensors 12, 15 and 16 connect by wired connection 17 to a respective node device, whereas the sensors 13 and 14 connect by a wireless connection 18 to a respective node device, indicated by dash-dot lines. It will be appreciated that the sensors 12-16 may be external of or internal, i.e. integrated in a network node device. In the present embodiment, data exchange over the connections 17 and 18 is also in accordance with the Zigbee protocol.

Network relay nodes 4, 6 may bridge a communication distance between neighbouring network end nodes 3, 5 or 5, 8 if such end nodes 3, 5, 8 are not capable of establishing a direct communication connection between these end nodes. It is noted that network relay nodes 4, 6 besides extending the network range, may also support application data communication of a same variety of electric or electronic devices as mentioned above in connection with the end nodes 3, 5, 8. Further, an end node and relay node may be comprised in a single physical device. A node device may be mains or battery operated, for example.

The gateway device 2 operates as a network control or coordinator device, which may provide access 11 to other networks, such as the Internet 10, for example. Such a network control or coordinator device is also called a backend or network access device. The gateway device 2 may be deployed in the network 1 or remote of the network 1. For communication purposes, the gateway 2 may comprise integrated transceiver equipment, that may directly connect to a data processing part of the gateway 2, for example by a universal serial bus, USB, port or the like, and comprises communication functionality for exchanging data packets or messages with the network nodes in the network 1 using a same protocol as the network node devices 3-8, i.e. in the present example the Zigbee communication protocol.

The network node devices 3-8 may communicate 9 directly with the gateway device 2 or, as described above, messages or data packets may be relayed to the gateway device 2 via neighbouring network relay nodes 4 in the mesh network 1. The network node devices 3-8 are further configured for exchanging data messages or data packets with one or a plurality of the node devices in their neighbourhood.

Messages that are generated in a network node 3-8, and forwarded to the gateway 2 are generally referred to as uplink messages or uplink traffic. Messages that are forwarded from the gateway 2 to a network node 3-8 are referred to as downlink messages or downlink traffic. When not explicitly mentioned, the node devices 3-8 and the gateway 2 are arranged for communicating messages or data packets in the network 1 of the present disclosure in either one or both of a unicast and broadcast transmission mode.

In a Zigbee enabled communication network, the ZigBee routing algorithm uses a path cost metric for route comparison during route discovery and maintenance. To allow neighbouring node devices to communicate their incoming link costs to each other and to maintain a neighbor node table and routing table for calculating best routing paths, a link status command message or frame is periodically transmitted among the node devices in the network. In accordance with the present disclosure, the link status command message or frame is applied for exchanging the sensor related data, i.e. the application data.

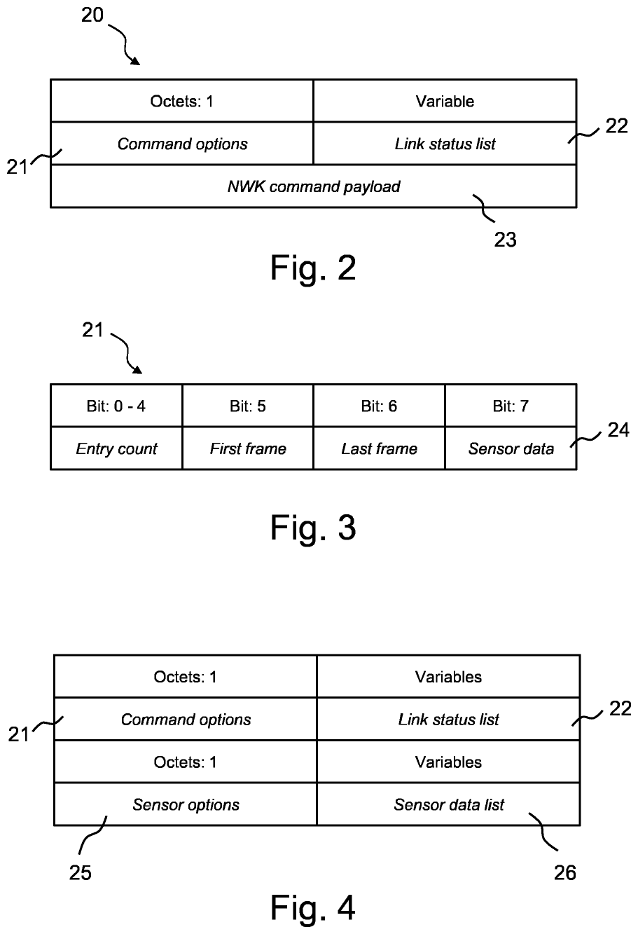

FIG. 2 discloses the present link status command format in accordance with the Zigbee specification, issued by the ZigBee Standards Organization, which Zigbee specification is herein fully incorporated by reference.

The link status command message or frame 20 comprises a one octet wide Command options field 21, a Link status list field 22, occupying a variable number of octets, and a Network commands payload field, i.e. NWK command payload field 23.

As shown in FIG. 3, the Command options field 21 comprises a five bit wide Entry count sub-field, comprising a link status entry number, a one bit First rame sub-field or flag and a one bit Last frame sub-field or flag. The Entry count sub-field indicates the number of link status entries present in the Link status list. The First frame sub-field is set to “1” if this is the first frame of the sender's link status. The Last frame sub-field is set to “1” if this is the last frame of the sender's link status. If the sender's link status fits into a single frame, the First frame and Last frame bits shall both be set to 1.

In accordance with the present disclosure, as shown in FIG. 3, the spare last bit of the Command options octet, i.e. bit number 7, functions as a sensor data flag or application data flag 24, to indicate whether or not there is sensor data, i.e. application data, attached to the link status command message or frame 20. For example, a value “0” of bit number 7 flags that no sensor data is attached, while a value “1” flags that there is sensor data attached.

That is, If the sensor data flag is set to “1”, sensor data control bytes and/or sensor data payload data are appended to the link status command message or frame in the NWK command payload field 23 thereof.

The Link status list 22 provides the detailed link costs with neighbour nodes in the network.

FIG. 4 discloses a modified link status command format in accordance with the present disclosure. In case the Sensor data flag 24, i.e. bit 7 of the Command options field 21, is set to “1”, in accordance with the example above, the command options field and the link status list field turn into a one octet wide Sensor options field 25 and a Sensor data list field 26 of variable length, respectively. Or in general, a application data options field and a application data list, respectively.

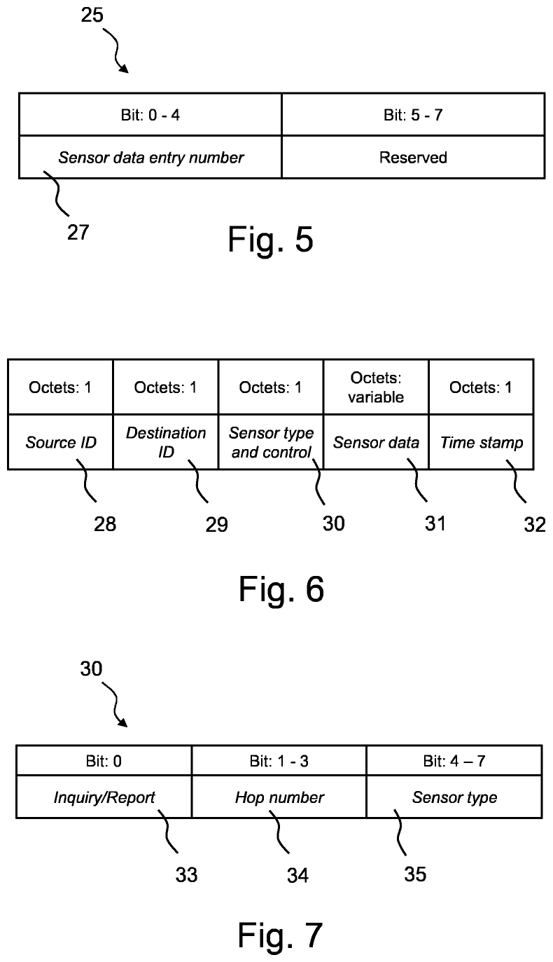

FIG. 5 shows a format of the Sensor options field 25 in accordance with the present disclosure. For each entry of application data, the data length is flexible and is set by the application data or Sensor data entry number 27, indicating the length of the application data to be exchanged, for example in number of data octets. In general, five bits of the available octet may be sufficient, such that the remaining three bits may be reserved for other purposes.

FIG. 6 discloses a sensor data entry format for sensor related data, i.e. application data, included in the NWK command payload field 23, according to the present disclosure. For each sensor data entry, the length of the Sensor data field 31 is variable, such that sensors requiring different data length can be flexibly handled.

The first two bytes or octets are the data Source identification, ID, 28 and data Destination identification, ID, 29 of the sensor data, which indicate the source of the sensor data and the destination the sensor data are delivered, respectively. Of course, each sensor at each node device shall have a unique sensor ID. For Zigbee systems, each node has a two bytes short address. The sensor ID at a node device may have a unique mapping relation to the short address.

The third byte includes Sensor type and control information 30. Sensor type may indicate whether the sensor is one of a humidity, temperature, Infra Red, IR, radiation, Carbon Monoxide, Carbon Dioxide, generally designated COₓ, actuators, camera systems, alarm systems, or other type of sensor. The sensor data length may relate to the type of sensor. The last byte 32 of the sensor data entry format is a Time stamp, that relates to the at which the sensor data are generated, for example.

FIG. 7 shows, in accordance with the present disclosure, a format of the Sensor type and control information 30, comprising a one bit sensor or application data Request/report flag 33, a four bit maximum node Hop number 34, and the Sensor type or application data type 35, as already mentioned above.

For example, a bit value “0” of the Request/report flag 33 indicates whether this piece of sensor data contains requested data or reported data. That is, sensor data automatically reported by a node device or a gateway in the network or sensor data that a particular sensor reports based on a request, for example. A bit value “1” of the Request/report flag 33 indicates in this example a request or inquiry for sensor data, i.e. application data in general.

For example, a gateway or a node device in the network may send a sensor data request or inquiry message using the link status command message in accordance with the present disclosure, by setting the Request/report flag 33 to “1”. The reporting sensor sends its sensor data by setting the Request/report flag 33 to “0”. Accordingly, sensor data request or inquiry and sensor response can be both handled with the modified link status command message or frame in accordance with the present disclosure.

Bit 1 to 3 of the Sensor type and control information 30 represent the maximum node Hop number 34 over which the sensor request or report data can be delivered. For example, If the maximum node hop number is set to zero, the nodes receiving the sensor data will not forward the sensor data anymore. If the sensor hop number has a value of one or higher, the sensor data will be forwarded and the hop number will be decreased by one before each resending. The sensor data will not be forwarded until the hop number is decreased. In practice, the maximum node hop number shall be set according to the estimation of the distance between the source node and the destination node of the application data.

Bit 4 to 7 of the Sensor type and control information 30 record the sensor type, as mentioned above. A specific number may be assigned to each type of sensors.

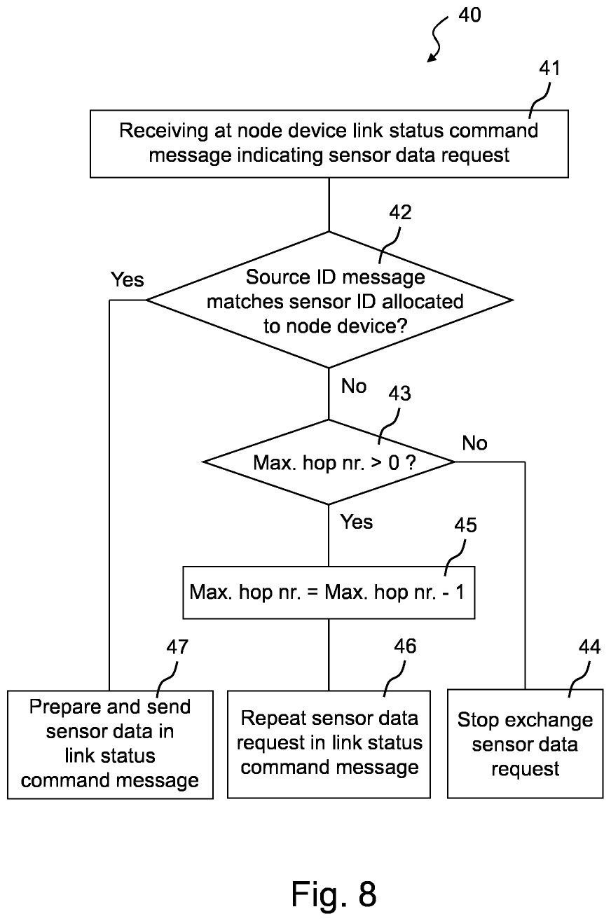

FIG. 8 illustrates, in a flow charge type diagram 40, a method of operation of a node device in accordance with the Zigbee link status command format of the present disclosure. In the flow chart type diagram, the normal flow of operation runs from the top to the bottom of the sheet. In all other cases, an arrow indicates the flow direction.

In accordance with the present disclosure, in the event that a node device receives a link status command message indicating a sensor data request, i.e. a request for application data, block 41 ‘Receiving at node device link status command message indicating sensor data request’, and the sensor data source ID in this request does not match a sensor data source ID allocated to the receiving node device, decision block 42 ‘Source ID message matches sensor ID allocated to node device?’ result ‘No’, the received sensor data request will be repeated, block 46 ‘Repeat sensor data request in link status command message’, by the receiving node device in a link status command message only if the maximum node hop number in the received request message is unequal zero, decision block 43 ‘Max. hop nr. >0?’ result ‘Yes’, and after the maximum node hop number is decreased by one, i.e. block 45 ‘Max. hop nr.=Max. hop nr.−1. Otherwise, i.e. decision block 43 result ‘No’, the received request will not be further transmitted by the receiving node, i.e. block 44 ‘Stop exchange sensor data request’.

The request for sensor data, i.e. application data, will not be forwarded by the receiving node device in a link status command message until the maximum node hop number is decreased. In this manner spreading of the request for application data in the network is effectively controlled.

When, however, the sensor data source ID in the request does match a sensor data source ID allocated to the receiving node device, i.e. decision block 42 result ‘Yes’, the receiving node device prepares and forwards the requested sensor data, or application data, in a link status command message in accordance with the present disclosure, addressed to a requesting gateway or an other destination node device in the network, i.e. block 47 ‘Prepare and send sensor data in link status command message’.

It is noted that the respective node device will have to set the application data request/report flag in the link status command message exchanged by this node device to signal report of application data, as well as the destination ID, maximum hop number and other parameters disclosed above.

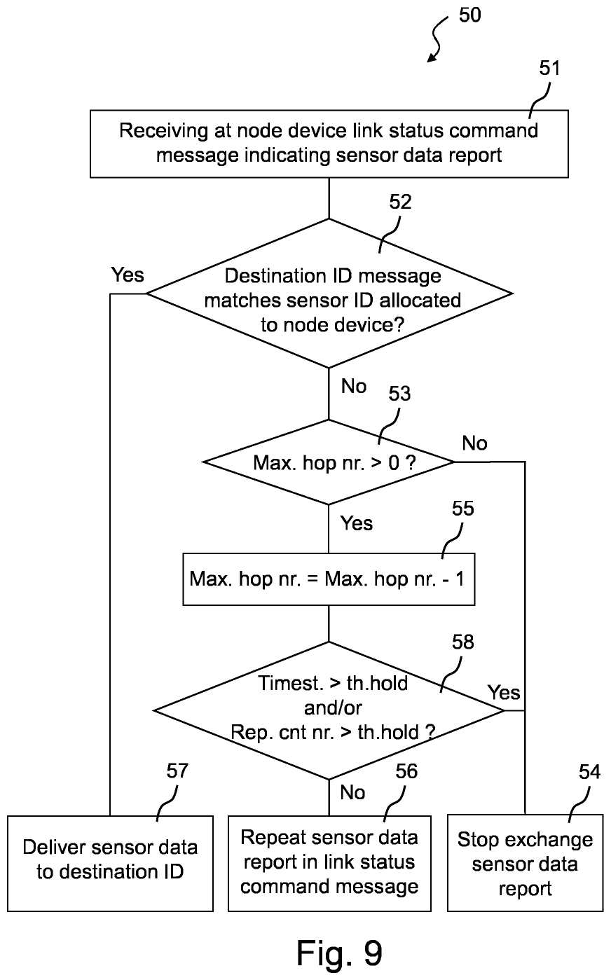

FIG. 9 illustrates, in a flow charge type diagram, operation of a node device with the Zigbee link status command format reporting sensor data, in accordance with the present disclosure. When a node device receives a link status command message comprising sensor data, i.e. application data, indicating sensor data report, i.e. block 51 ‘Receiving at node device link status command message indicating sensor data report’, and the sensor destination ID in this report message does not match a sensor ID allocated to the receiving node device, i.e. decision block 52 ‘Destination ID message matches sensor ID allocated to node device?’ result ‘No’, the sensor data will be repeated by the receiving node in a link status command message, i.e. block 56 ‘Repeat sensor data report in link status command message’, and only if the maximum node hop number in the received report message is unequal zero, i.e. decision block 53 ‘Max. hop nr. >0?’ result ‘Yes’ and after the maximum node hop number is decreased by one, i.e. block 55 ‘Max. hop nr.=Max. hop nr.−1’.

Otherwise, i.e. decision block 53 result ‘No’, the received report data will not be further transmitted by the receiving node, i.e. block 54 ‘Stop exchange sensor data report’.

Accordingly, in the case of a link status command message indicating a report of sensor data, i.e. application data, the sensor data will not be forwarded by the receiving node device in a link status command message until the maximum node hop number is decreased.

If a node device in the network receives a link status command message having the maximum node hop number equal to zero, the node device will not forward the received sensor data or application data.

When, however, the sensor data destination ID in the report message does match a sensor data destination ID allocated to the receiving node device, i.e. decision block 52 result ‘Yes’, the receiving node device delivers the received sensor data, or application data, to the destination, i.e. block 57 ‘Deliver sensor data to destination ID’.

Note that the receiving node device may also be a gateway device, requesting sensor data, for example.

To further prevent spreading of application data in the network, in accordance with the present disclosure, the application data is also not forwarded by a receiving node when at least one of the timestamp indicates a time older than a set time threshold, and a repeat count number of repeated same application data by the receiving node device exceeds a set repeat threshold, i.e. decision blocks 58 ‘Timest. >th.hold and/or Rep. cnt nr. >th.hold ?’ result ‘Yes’.

For example, a repeat threshold may be set at a value of five, if a node may receive more than five repeated application data reports from the neighbour nodes in the network. The receiving node will not forward the application data because with such an amount it is validly assumed that this application data is sufficiently broadcasted in the network. With the above measures, it is expected that the application data are broadcasted in a certain scope and will not cause a data storm in the network.

In a further extension of the present disclosure, in a parent/child environment, a parent receiving reports in unicast from its ZED child sensor can choose to forward the data as link status command messages or frames, or the child could piggyback same on some other communication to the parent and then the parent may combine those application data and send same out through the link status command packets.

Except for delivering the application data through the link status command messages, other multiple hop control commands not requiring a strict delay may also utilize the link status command messages in accordance with the present disclosure to transmit information.

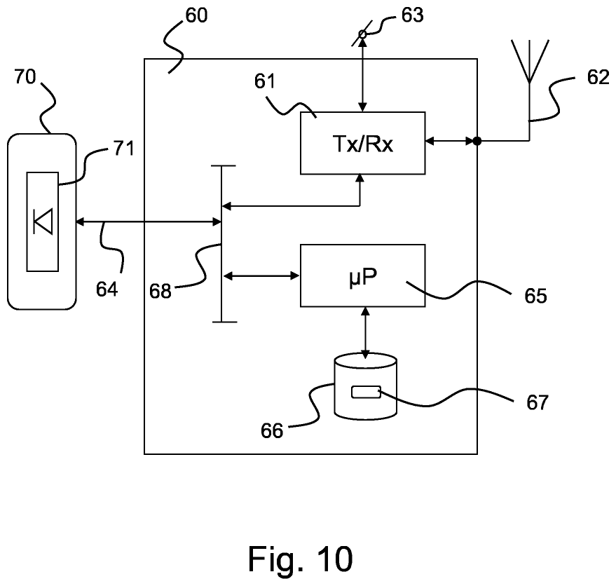

FIG. 10 illustrates, schematically, a circuit diagram of an embodiment of a node device in accordance with the present disclosure. The node device 60 comprises a transceiver, Tx/Rx, module 61 arranged for a wireless 62 or wired 63 exchange of messages or data packets with a gateway and/or other node devices, inclusive relay node devices, in a network of communicatively interconnected network node devices. The transceiver 61 may be configured to operate in accordance with any of the data communication technologies and protocols mentioned above with reference to FIG. 1, in one or both of a broadcast and unicast mode of operation.

The node device 60 further comprises at least one data processor or controller 65, and at least one data repository or storage or memory 66, among others for storing computer program code instructions which, when loaded and run on to the one or more processor or controller 65, configure the node device 60 to operate in accordance with the present disclosure for exchanging application data in periodically exchanged message by the node device, such as the link status command message or frame in a Zigbee enabled network environment.

Parameters and information about sensor IDs, maximum node hop numbers, time stamp data, repeat counts and respective thresholds, repetition rates and other attributes in accordance with the present disclosure for the node device may be stored 67 in the repository 66, or in a separate memory or storage accessible to the at least one processor or controller 65. The at least one processor or controller 65 communicatively interacts with and controls the transceiver 61 and the at least one repository or storage 66 via an internal data communication bus 48 of the gateway device 40.

The node device 60 may be part of or operatively connect 64 to an electric or electronic device, such as lighting device 70, comprising a lighting module 71, preferably a LED lighting module, operation of which may be controlled by the node device 60 from or through a network gateway, or by a remote control device, for example. As mentioned above, instead of or in addition to a lighting device, a node device may control several other electric or electronic devices, operatively connected in a network in accordance with the present disclosure.

Those skilled in the art will appreciate that the solution according to the present disclosure is applicable in a communication network comprising plural node devices and gateway devices, not limited to the number of nodes shown in the example of FIG. 1. Further, values of flags or parameters and decision criteria and the like may be chosen differently from the examples presented, without departing from the present disclosure.

Other variations to the disclosed examples can be understood and effected by those skilled in the art in practicing the claimed disclosure, from a study of the drawings, the disclosure, and the appended claims. In the claims, the word “comprising” does not exclude other elements or steps, and the indefinite article “a” or “an” does not exclude a plurality. A single processor or transceiver or other unit may fulfil the functions of several items recited in the claims. The mere fact that certain measures are recited in mutually different dependent claims does not indicate that a combination of these measured cannot be used to advantage. A computer program may be stored/distributed on a suitable medium such as an optical storage medium or a solid-state medium supplied together with or as a part of the hardware, but may also be distributed in other forms, such as via the Internet or other wired or wireless telecommunication systems. Any reference signs in the claims should not be construed as limiting the scope thereof.

1. A method of exchanging application data by a node device in a network of communicatively interconnected node devices, said node device periodically exchanges operational messages in said network, said method comprises;
exchanging, by said node device, said application data in said network by attaching said application data to said periodically exchanged operational messages;
wherein said application data are sensor related data and said operational message is a link status command message used for said node devices to communicate an incoming link cost to each other of the communicatively interconected devices in a mesh communication enabled network.

2. (canceled)

3. The method according to claim 1, wherein said application data are time-insensitive data.

4. The method according claim 1, wherein said sensor related data are received from a sensor operationally connected to a node device in the network.

5. The method according to claim 1, wherein said link status command message comprises a command options field, a link status list field and a network command payload field, and wherein said command options field comprises an application data flag that is set when application data are attached to said link status command message.

6. The method according to claim 5, wherein when said application data flag is set, said command options field comprises application data options, said link status list field comprises an application data list, and said network command payload field comprises said application data to be exchanged.

7. The method according to claim 6, wherein said application data options comprise an application data entry number, and said network command payload field comprises an application data source ID, an application data destination ID, application data type and control information, said application data to be exchanged, and time stamp data.

8. The method according to claim 7, wherein said application data type and control information comprises an application data request/report flag, a maximum node hop number, and an application data type indication.

9. The method according to claim 8, wherein when a node device in said network receives a link status command message relating to application data indicating an application data request and said application data source ID match an application data source ID allocated to a receiving node device, said receiving node device prepares and forwards requested application data in a link status command message.

10. The method according to claim 8, wherein when a node device in said network receives a link status command message relating to application data indicating an application data request and said application data source ID does not match an application data source ID allocated to a receiving node device, said application data will be repeated by said receiving node device in a link status command message if said maximum node hop number is unequal zero and after said maximum node hop number is decreased by one.

11. The method according to claim 8, wherein when a node device in said network receives a link status command message relating to application data indicating application data report and said application data destination ID does not match an application data destination ID allocated to a receiving node device, said application data will be repeated by said receiving node in a link status command message if said maximum node hop number is unequal to zero and after said maximum node hop number is decreased by one.

12. The method according to claim 9, wherein said application data is not forwarded by said receiving node when at least one of: timestamp indicates a time older than a set time threshold, and a repeat count number of repeated same application data by said receiving node device exceeds a set repeat threshold.

13. The method according to claim 10, wherein said network node device operates as a gateway device communicatively connected to said node devices in said network.

14. A node device, in particular a lighting device, arranged for operating in accordance with claim 9.

15. A computer readable storage medium storing a non-transitory computer program code instructions which, when loaded on to one or more processors, causes said one or more processors to perform the method in accordance with claim 1.
